(19) United States
(12) Patent Application Publication
(10) Pub. No.: US 2006/0250370 A1
(43) Pub. Date: Nov. 9, 2006

(54) METHOD AND RELATED APPARATUS FOR INPUTTING CHARACTERS

(76) Inventors: Ya-Ping Ko, I-Lan City (TW); Wen-Way Chen, Hsin-Chu Hsien (TW)

Correspondence Address: NORTH AMERICA INTELLECTUAL PROPERTY CORPORATION, P.O. BOX 506, MERRIFIELD, VA, 22116, US

(21) Appl. No.: 11/381,360

(22) Filed: May 3, 2006

(30) Foreign Application Priority Data
May 3, 2005 (TW) 094114242

(51) Int. Cl. G09G 5/00

(52) U.S. Cl. 345/168

(57) ABSTRACT

A method and related apparatus for inputting characters. The number of buttons of a portable electric device is smaller than the number of buttons of a keyboard of a computer. Therefore, it takes more time and is more inconvenient to key in characters into the portable electric device. While inputting characters in the portable electric device, two or more adjacent buttons are simultaneously pressed, such that the number of pressing buttons can be reduced.

### BACKGROUND OF THE INVENTION

1. Field of the Invention

The present invention relates to a method for inputting characters, and more particularly, to a method for inputting characters into a portable electronic device.

2. Description of the Prior Art

With the advantages of convenience, light weight, and easy carrying, a portable electronic device, such as a mobile phone, a personal data assistant (PDA), or a hand-held computer, allows a user communicate with others and access data anytime and anywhere.

Generally, the physical size of the portable electronic device is small, and thereby buttons of such a device are much fewer in number than those of a keyboard of a computer. It is more inconvenient to input characters into the portable electronic device than in the computer.

Generally, the English alphabet having twenty-six letters and the Chinese phonetic notation having thirty-seven letters are arranged on limited buttons of the portable electronic device. The user must press buttons many time or press buttons with a word-selecting function for character input. Please refer to FIG. 1, which is an arrangement of English letters in a prior art mobile phone. Suppose that the user wants to input an English letter “C”. The user must press the button “2” three times, and then the display shows “C” accordingly. If inputting “money”, the user has to press buttons “66666633999” in sequence, which requires pressing buttons eleven times. The drawback is that the number of button pressings is large.

Suppose that a word-selecting function is used for character input. When inputting an English word of “money”, the user has to press buttons “66639” sequentially, then all possible words would be displayed, such as “moody” and “money”, and be selected by the user. The drawback of the word-selecting function is that the first displayed English word is usually not the one the user wants. The user still has to select the word by pressing buttons many times. Therefore, it requires an easier and more convenient method for inputting characters with the limited buttons of such a portable electronic device.

### SUMMARY OF THE INVENTION

It is therefore a primary objective of the claimed invention to provide a method and related device for inputting characters to solve the above-mentioned problems.

The claimed invention provides a method for inputting characters applied in an electronic device. The electronic device comprises a plurality of circuit switches and a plurality of bridges. The method comprises displaying a first character when a plurality of adjacent circuit switches is simultaneously triggered by a bridge.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an arrangement of English letters in a prior art mobile phone.

FIG. 2 is an arrangement of English letters of an electronic device according to the present invention.

FIG. 3 is a diagram of a T-shaped bridge positioned between two adjacent input units according to the present invention.

FIG. 4 is a diagram of only pressing one input unit.

FIG. 5 is a diagram of simultaneously pressing two adjacent input units.

FIG. 6 is a top view of a T-shaped bridge positioned beneath four adjacent input units.

FIG. 7 and 8 are other types of bridges based on the present invention.

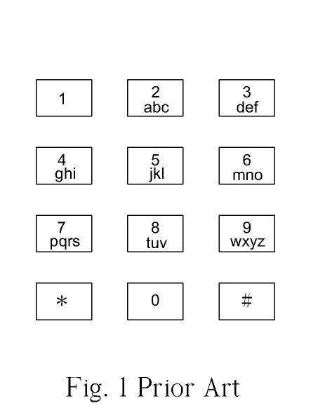

### DETAILED DESCRIPTION

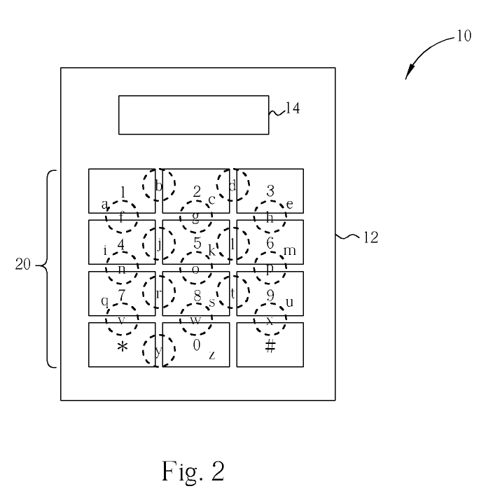

Please refer to FIG. 2, which is an arrangement of English letters of an electronic device 10 according to the present invention. The electronic device 10 comprises a housing 12, a display panel 14 for displaying information, and a plurality of input units (e.g. buttons) 20 positioned on the housing 12. In the first embodiment of the present invention, two adjacent input units are simultaneously pressed to input words. The present invention arranges twenty-six English letters on the limited input units 20 of the electronic device 10, as shown in FIG. 2. Pressing input unit “1” displays “a”; simultaneously pressing input units “1” and “2” displays “b”; pressing input unit “2” displays “c”; simultaneously pressing input units “2” and “3” displays “d”; pressing input unit “3” displays “e”; simultaneously pressing input units “1” and “4” displays “f”; simultaneously pressing input units “2” and “5” displays “g”; simultaneously pressing input units “3” and “6” displays “h”; pressing input unit “4” displays “i”; simultaneously pressing input units “4” and “5” displays “j”; and so on. Obviously, other arrangements are equally possible.

According to the arrangement of English letters in FIG. 2, if inputting “c”, the user just has to press input unit “2” once, then “c” is displayed on the display panel 14. To input the word “money”, by pressing input unit “6”, simultaneously pressing input units “5” and “8”, simultaneously pressing input units “4” and “7”, pressing input unit “3”, and finally pressing input units “*” and “0”, totally requires pressing input units five times. Compared with the prior art requiring pressing input units eleven times, the present invention reduces the input unit presses, and immediately shows the required word or letters on the display panel 14 without using the word-selecting function.

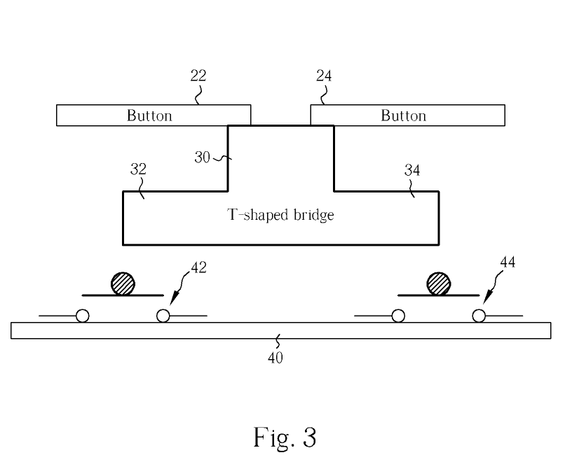

In order to implement the present invention of simultaneously pressing two adjacent input units for a letter input, a feasible method is disclosed as follows. Generally, there is a circuit board 40 having a plurality of circuit switches inside the electronic device 10. A character is shown on the display panel 14 according to the pressed circuit switch. Please refer to FIG. 3, which is a diagram of a T-shaped bridge 30 positioned between two adjacent input units 22 and 24 according to the present invention. The input unit 22 and the input unit 24 are adjacent and corresponding to the circuit switches 42 and 44 on the circuit board 40, respectively. The T-shaped bridge 30 is positioned beneath the input units 22 and 24. Two contact portions 32 and 34 of the T-shaped bridge 30 are used for respectively triggering the circuit switches 42 and 44. Therefore, the present invention of simultaneously triggering two adjacent input units for a character input can be accomplished.

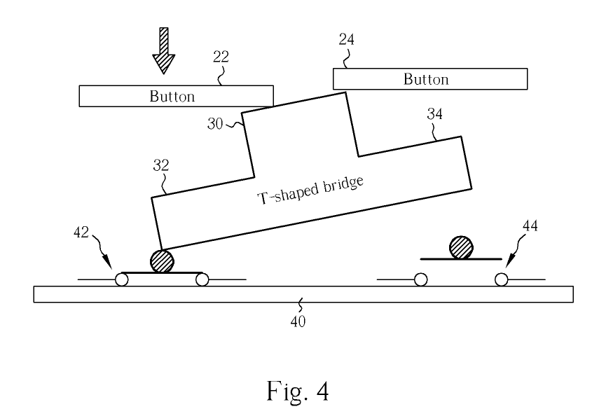

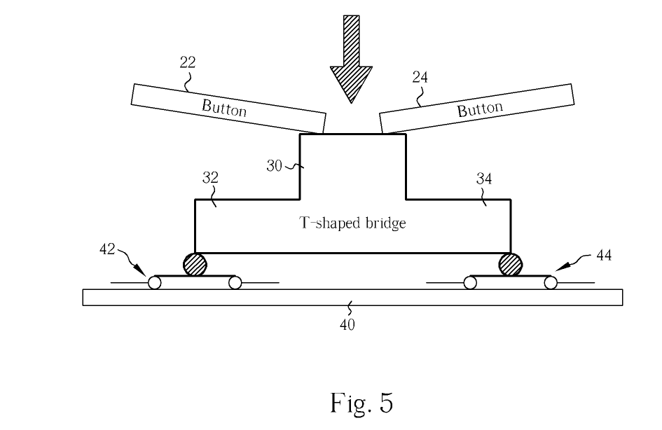

Please refer to FIG. 4, which is a diagram of pressing one input unit. Suppose that the user only presses the input unit 22. Only input unit 22 receives the force so that the left end of the T-shaped bridge 30 inclines while the right end rises. Then the contact portion 32 presses the circuit switch 42 so that a first character corresponding to the pressed input unit 22 is shown on the display panel 14. Please refer to FIG. 5, which is a diagram of simultaneously pressing two adjacent input units. Suppose that the user simultaneously presses the input units 22 and 24. Thus, the T-shaped bridge 30 has a vertical displacement without any incline, so that the two contact portions 32 and 34 respectively trigger the circuit switches 42 and 44. Thus, a second character (other than the first character) corresponding to the pressed input units 42 and 44 is shown on the display panel 14.

The number of input units (buttons) formed on the portable electronic device 10 depends on different requirements, and thereby there is no limitation in the number of input units. For instance, the Chinese phonetic notation having thirty-seven characters requires more input units than the English alphabet does. The input units of FIG. 2 are not enough for the Chinese phonetic notation. The number of input units in FIG. 2 is twelve, and the number of two adjacent input units is seventeen, totally having twenty-nine inputs. Therefore, to add eight inputs in the arrangement of FIG. 2 for the Chinese phonetic input method can be achieved by simultaneously pressing three or more than three adjacent input units or non-adjacent input units, cooperating with direction keys, soft key, or side key, or including additional input units. Pressing three or more than three input units at the same time can be achieved by using two bridges.

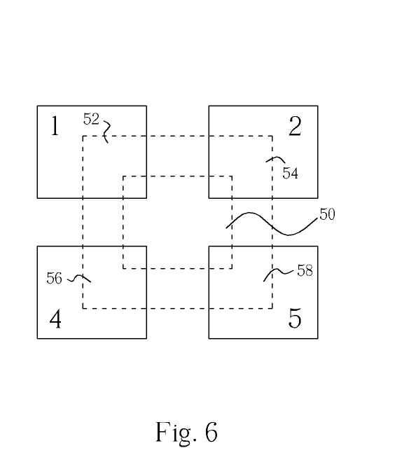

Another embodiment of the present invention is shown in FIG. 6. FIG. 6 is a top view of a T-shaped bridge 50 positioned beneath four adjacent input units. If simultaneously pressing input units “1”, “2”, “4”, and “5” for an input, the T-shaped bridge 50 beneath the four input units lower down in the vertical direction, and four contact portions 52, 54, 56, and 58 respectively press circuit switches on the circuit board 40 correspondingly and at the same time. If only pressing input units “1” and “4”, the contacts 52 and 56 descend and press the corresponding circuit switches. Simultaneously, the contacts 54 and 58 rise and the corresponding circuit switches are not pressed. If only pressing the input unit “1”, the contact 52 descends to press the corresponding circuit switch while the positions of the contacts 54, 56, and 58 are higher than the position of the contact 52. The T-shaped bridge of the present invention is capable of simultaneously pressing two or four adjacent input units, or pressing one input unit for a letter input. Additionally, the present invention can be implemented in any input method, such as English input, Chinese phonetic input, or other language input.

As mentioned above, the present invention simultaneously presses a plurality of input units to input characters, and thereby there is a plurality of T-shaped bridges beneath the plurality of input units 20. Each T-shaped bridge includes a plurality of contacts, each contact for pressing a circuit switch. The present invention presses one or more than one circuit switch simultaneously to display the required letter accordingly. In addition, the electronic device 10 of the present invention can be a mobile phone, a personal data assistant (PDA), or a household telephone whose input units are much fewer in number than those of a keyboard of a computer.

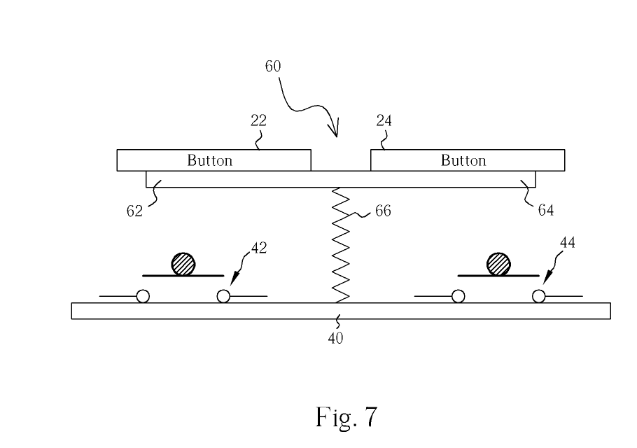

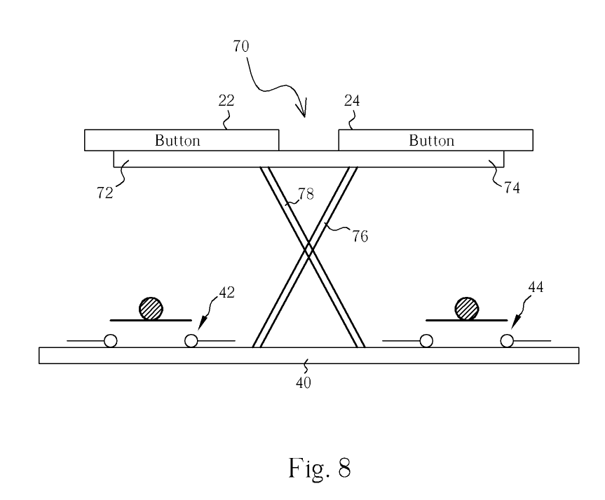

The bridge of the present invention is not limited as the T-shaped bridges of FIG. 3 and FIG. 6. Please refer to FIGS. 7 and 8, which are other types of bridges. The bridge 60 of FIG. 7 comprises two contacts 62 and 64. The bridge 60 is positioned between the input units 22 and 24 and the circuit board 40 via a spring 66. An end of the spring 66 is connected to the middle of the contacts 62 and 64, and the other end is connected to the circuit board 40. The bridge 70 of FIG. 8 comprises two contacts 72 and 74. The bridge 70 is positioned via two crossed rods 76 and 78. When pressing input units, the two rods 76 and 78 move along the plane of the two contacts 72 and 74, so that the two contacts 72 and 74 are capable of pressing the circuit switches 42 and 44 respectively. Alternately, the two rods 76 and 78 move along the circuit board 40.

Compared with the prior art, the present invention provides an easier input method and related device whose input units are much fewer in number than those of the keyboard of the computer. The present invention reduces the number of inputs by pressing adjacent input units at the same time, and the required letters or words can be displayed immediately and precisely.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for inputting characters applied in an electronic device, the electronic device comprising a plurality of circuit switches and a plurality of bridges, the method comprising:
displaying a first character when a plurality of adjacent circuit switches is simultaneously triggered by a bridge.

2. The method of claim 1 further comprising:
displaying a second character when a single circuit switch is triggered by the bridge.

3. The method of claim 1 comprising displaying the first character when two adjacent circuit switches are simultaneously triggered by the bridge.

4. The method of claim 1 comprising displaying the first character when four adjacent circuit switches are simultaneously triggered by the bridge.

5. The method of claim 1 further comprising:
displaying a third character when a plurality of circuit switches is simultaneously triggered by two bridges.

6. The method of claim 1 further comprising displaying the first character on a display of the electronic device.

7. An electronic device capable of inputting characters by triggering adjacent input units, the electronic device comprising:
a housing;
a plurality of input units disposed on the housing;
a circuit board disposed inside the housing, the circuit board comprising a plurality of circuit switches; and
a plurality of bridges, positioned between a plurality of input units and the circuit board, each of the bridges corresponding to a plurality of input units, each bridge comprising a plurality of contact portions, each of the contact portions corresponding to one circuit switch;
wherein the contact portions are for triggering the circuit switches when a force is applied through the input units to the contact portions.

8. The electronic device of claim 7 wherein the plurality of bridges is T-shaped bridges.

9. The electronic device of claim 7 comprising a mobile phone or a personal data assistant (PDA).

10. The electronic device of claim 7 wherein each bridge comprises two contact portions and each bridge is positioned beneath two input units.

11. The electronic device of claim 7 wherein each bridge comprises four contact portions and each bridge is positioned beneath four input units.

12. The electronic device of claim 7 wherein each bridge further comprises a connecting end for connecting a plurality of adjacent input units.

13. The electronic device of claim 7 wherein each bridge is positioned between two adjacent input units and two adjacent circuit switches corresponding to the two adjacent input units.

14. The electronic device of claim 7 wherein each bridge is positioned between four adjacent input units and four adjacent circuit switches corresponding to the four adjacent input units.

15. The electronic device of claim 7 further comprising a plurality of supporters, an end of each supporter connected to a bridge and the other end connected to the circuit board.

16. The electronic device of claim 15 wherein each supporter comprises a spring.

17. The electronic device of claim 15 wherein each supporter comprises two crossed rods.
